(19) United States
(12) Patent Application Publication
(10) Pub. No.: US 2023/0185066 A1
(43) Pub. Date: Jun. 15, 2023

(54) IMAGING LENS, AND CAMERA MODULE AND ELECTRONIC DEVICE COMPRISING SAME

(71) Applicant: LG ELECTRONICS INC., Seoul (KR)

(72) Inventors: Kwanhyung KIM, Seoul (KR); Dongryeol LEE, Seoul (KR); Seunggyu LEE, Seoul (KR); Jun PARK, Seoul (KR)

(73) Assignee: LG ELECTRONICS INC., Seoul (KR)

(21) Appl. No.: 17/907,168

(22) PCT Filed: Jun. 24, 2020
(86) PCT No.: PCT/KR2020/008218

§ 371 Date: Sep. 23, 2022

Related U.S. Application Data
(60) Provisional application No. 62/994,293, filed on Mar. 25, 2020.

(51) Int. Cl. G02B 17/08; G02B 13/00; G03B 17/17

(52) U.S. Cl. CPC G02B 17/0808; G02B 13/0065; G02B 13/0035; G03B 17/17; G03B 30/00

(57) ABSTRACT

The present disclosure relates to an imaging lens, a camera module and an electronic device including the same. The imaging lens according to an embodiment of the present disclosure includes a rear mirror comprising a transmission area and a reflection area for reflecting light incident from an object side to the object side; a front mirror for reflecting the light reflected from the reflection area of the rear mirror to an image side; and a lens group comprising a plurality of lenses for transmitting the light reflected from the front mirror to an image surface, wherein the lens group is all disposed between the rear mirror and the front mirror based on an optical axis, thereby increasing the brightness of the lens, enhancing the resolution, and suppressing the increase in thickness.

### TECHNICAL FIELD

The present disclosure relates to an imaging lens, a camera module and an electronic device including the same, and more particularly, to an imaging lens capable of increasing the brightness of a lens by positioning all lenses in between two reflective mirrors, and a camera module and an electronic device including the same.

### BACKGROUND ART

Recently, as the functions of mobile terminals are diversified and the size decreases, high performance and thin thickness are required for a camera module installed in a mobile terminal. However, in order to implement a camera having a bright and high telephoto performance, the height or thickness of the camera module needs to be increased. Hence, there is a limit to miniaturization.

The telephoto camera has a longer focal length due to a geometrical structure and has a longer overall length compared to a diameter. Thus, it was difficult to use in a camera that requires a thin thickness, such as a smartphone. In order to solve the thickness problem of the telephoto camera, a periscope type telephoto camera that uses a prism to bend the path of an incident light by 90 degrees has recently started to be used.

FIG. 1 shows a structure of a lens module including a conventional telephoto lens of a periscope type. As shown in the drawing, in such a periscope type structure, the lens module is disposed in a mobile terminal in a direction perpendicular to the thickness direction of the mobile terminal. Accordingly, when the diameter H1 of the incident light of the lens module is increased, the thickness of the mobile terminal should increase in proportion.

The diameter of the incident light is an important factor affecting the brightness and resolution of a lens. In general, when the diameter of the incident light increases, the brightness Fno of the lens increases. Therefore, when the periscope type lens module is included in the mobile terminal, there is a limit in increasing the incident light diameter of the lens module.

Accordingly, the brightness of the lens of the telephoto camera of the periscope type applied to the mobile terminal is 3.6 or higher, which is relatively low compared to the brightness of general camera lenses.

Meanwhile, a telescope uses a catadioptric optical system using two reflecting mirrors. A typical telescope is designed to have a lens brightness (Fno) of 8.0. Therefore, when a telescope lens is applied to a small optical system with a sensor size of 1 μm, there is a problem in that the brightness is too low and the resolution is deteriorated. In addition, since the catadioptric lens has a very long overall length compared to the diameter, it is difficult to be applied to a mobile terminal requiring a thin thickness.

### DISCLOSURE

### Technical Problem

In order to solve the above problems, an object of the present disclosure is to provide an imaging lens capable of suppressing an increase in the thickness of a lens by disposing all lenses in between two reflective mirrors.

Meanwhile, in order to solve the above problem, another object of the present disclosure is to provide an imaging lens capable of increasing the brightness performance of the lens by disposing all the lenses in between two reflective mirrors and increasing an entrance pupil diameter compared to a lens thickness.

Meanwhile, in order to solve the above problem, another object of the present disclosure is to provide an imaging lens capable of increasing the resolution of the lens and removing image noise, by allowing a image surface to exist on an object-side surface of a first lens in a lens group, and allowing the hole diameter of a rear mirror to be larger than that of a front mirror.

The problems of the present disclosure are not limited to the problems mentioned above, and other problems not mentioned will be clearly understood by those of ordinary skill in the art to which the present disclosure belongs from the following description.

### Technical Solution

An imaging lens according to an embodiment of the present disclosure for achieving the above object includes: a rear mirror comprising a transmission area and a reflection area for reflecting light incident from an object side to the object side; a front mirror for reflecting the light reflected from the reflection area of the rear mirror to an image side; and a lens group comprising a plurality of lenses for transmitting the light reflected from the front mirror to an image surface, wherein the lens group is all disposed between the rear mirror and the front mirror based on an optical axis.

Meanwhile, in the imaging lens according to an embodiment of the present disclosure for achieving the above object, a center point of the transmission area, on the optical axis, is located between an image-side surface of a lens located closest to an image side among the plurality of lenses and the image surface.

Meanwhile, in the imaging lens according to an embodiment of the present disclosure for achieving the above object, a diameter D1 of the front mirror is smaller than a diameter D2 of the transmission area of the rear mirror.

Meanwhile, in the imaging lens according to an embodiment of the present disclosure for achieving the above object, the lens group comprises a first lens located closest to the object side, wherein a diameter DL1 of the first lens is the smallest among diameters of lenses included in the lens group.

Meanwhile, in the imaging lens according to an embodiment of the present disclosure for achieving the above object, the diameter DL1 of the first lens is smaller than the diameter D1 of the front mirror.

Meanwhile, in the imaging lens according to an embodiment of the present disclosure for achieving the above object, the lens group comprises the first lens to an N-th lens (N is a natural number equal to or greater than 2) positioned in order from the object side to the image side, and when diameters of the first lens to the N-th lens are DL1 to DLN, respectively, a conditional expression DL1≤DL2≤ . . . ≤DLN-1≤DLN is satisfied.

Meanwhile, in the imaging lens according to an embodiment of the present disclosure for achieving the above object, a stop surface is positioned between the front mirror and an object-side surface of the first lens.

Meanwhile, the imaging lens according to an embodiment of the present disclosure for achieving the above object, further includes a front lens which transmits the light incident from the object side, has both surfaces that are flat, and positioned in the front mirror to the object side, and when a diameter of the front lens is D0 and a distance from the object-side surface of the front lens to an image surface is TTL, a conditional expression 0<TTL/D0≤0.7 is satisfied.

Meanwhile, in the imaging lens according to an embodiment of the present disclosure for achieving the above object, when a constant representing a brightness of the imaging lens is Fno, a conditional expression 0<Fno≤3.5 is satisfied.

Meanwhile, in the imaging lens according to an embodiment of the present disclosure for achieving the above object, when a half angle of view of the imaging lens is ANG, a conditional expression ANG≤6° is satisfied.

Meanwhile, in the imaging lens according to an embodiment of the present disclosure for achieving the above object, when an entrance pupil diameter of the imaging lens is EPD, and a diameter of the transmission area of the rear mirror is D2, a conditional expression D2/EPD≤0.8 is satisfied.

Meanwhile, in the imaging lens according to an embodiment of the present disclosure for achieving the above object, the front mirror is an aspherical mirror that has a negative power and has a convex image side surface.

Meanwhile, in the imaging lens according to an embodiment of the present disclosure for achieving the above object, the front mirror is a plano-concave type lens which has an object-side surface that is flat, and has an image-side surface that is concave, wherein a reflective coating layer capable of reflecting light is formed on the object-side surface of the front mirror.

Meanwhile, in the imaging lens according to an embodiment of the present disclosure for achieving the above object, the rear mirror is an aspherical mirror that has a positive power, and has a concave object-side surface.

Meanwhile, in the imaging lens according to an embodiment of the present disclosure for achieving the above object, the rear mirror comprises a diffractive element or a refractive element, wherein a reflective coating layer capable of reflecting light is formed on an image side surface of the diffractive element or the refractive element.

Meanwhile, in the imaging lens according to an embodiment of the present disclosure for achieving the above object, the refractive element is a meniscus shaped lens having a concave object-side surface.

Meanwhile, in the imaging lens according to an embodiment of the present disclosure for achieving the above object, the diffractive element is a flannel lens or a diffractive optical element (DOE).

Meanwhile, in the imaging lens according to an embodiment of the present disclosure for achieving the above object, a lens, a blue filter, or a polarizing filter is located in the transmission area of the rear mirror.

Meanwhile, a camera module according to an embodiment of the present disclosure for achieving the above object includes an imaging lens; a filter which selectively transmits light that passed through the imaging lens depending on a wavelength; and an image sensor for receiving the light that passed through the filter.

The details of other embodiments are included in the detailed description and drawings.

### Advantageous Effects

According to the present disclosure, there are the following effects.

The imaging lens according to an embodiment of the present disclosure has an effect of suppressing an increase in the thickness of a lens by disposing all lenses in between two reflective mirrors.

In addition, the imaging lens according to an embodiment of the present disclosure has the effect of increasing the brightness performance of the lens by disposing all the lenses in between two reflective mirrors and increasing an entrance pupil diameter compared to a lens thickness.

In addition, the imaging lens according to an embodiment of the present disclosure has the effect of increasing the resolution of the lens and removing image noise, by allowing a image surface to exist on an object-side surface of a first lens in a lens group, and allowing the hole diameter of a rear mirror to be larger than that of a front mirror.

The effects of the present disclosure are not limited to the above-mentioned effects, and other effects not mentioned will be clearly understood by those of ordinary skill in the art from the description of the claims.

### DESCRIPTION OF DRAWINGS

FIG. 1 is a diagram illustrating a structure of a conventional periscope type telephoto lens.

FIG. 2 is a diagram illustrating an imaging lens according to an embodiment of the present disclosure.

FIGS. 3 and 4 illustrate a mobile terminal including an imaging lens according to an embodiment of the present disclosure.

FIG. 5 is a diagram illustrating a path through which light is incident in an imaging lens according to an embodiment of the present disclosure.

FIG. 6 illustrates an entrance pupil diameter and a shielding area of the imaging lens of FIG. 2.

FIG. 7 illustrates a phenomenon in which stray light appears according to the diameter of a front mirror and a rear mirror in the imaging lens of FIG. 2.

FIG. 8 illustrates an example of a front mirror in the imaging lens of FIG. 2.

FIGS. 9 to 11 illustrate various examples of a rear mirror in the imaging lens of FIG. 2.

FIG. 12 illustrates each surface of the imaging lens of FIG. 2.

FIG. 13 is an MTF chart of the imaging lens of FIG. 2.

FIG. 14 is a graph illustrating distortion of the imaging lens of FIG. 2.

FIG. 15 illustrates a result of comparing an image photographed using the imaging lens of FIG. 2 with an image photographed using a conventional lens.

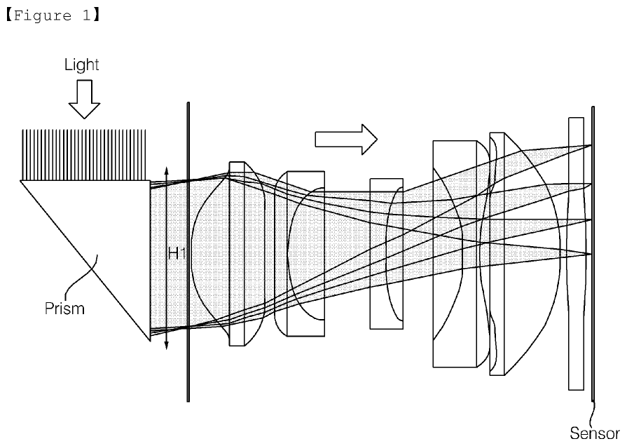

### MODE FOR INVENTION

Description will now be given in detail according to exemplary embodiments disclosed herein, with reference to the accompanying drawings. For the sake of brief description with reference to the drawings, the same or equivalent components may be denoted by the same reference numbers, and description thereof will not be repeated.

In general, suffixes such as “module” and “unit” may be used to refer to elements or components. Use of such suffixes herein is merely intended to facilitate description of the specification, and the suffixes do not have any special meaning or function.

In the present disclosure, that which is well known to one of ordinary skill in the relevant art has generally been omitted for the sake of brevity. The accompanying drawings are used to assist in easy understanding of various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are only used to distinguish one element from another.

It will be understood that when an element is referred to as being “connected with” another element, there may be intervening elements present. In contrast, it will be understood that when an element is referred to as being “directly connected with” another element, there are no intervening elements present.

A singular representation may include a plural representation unless context clearly indicates otherwise).

In the present application, it should be understood that the terms “comprises, includes,” “has,” etc. specify the presence of features, numbers, steps, operations, elements, components, or combinations thereof described in the specification, but do not preclude the presence or addition of one or more other features, numbers, steps, operations, elements, components, or combinations thereof.

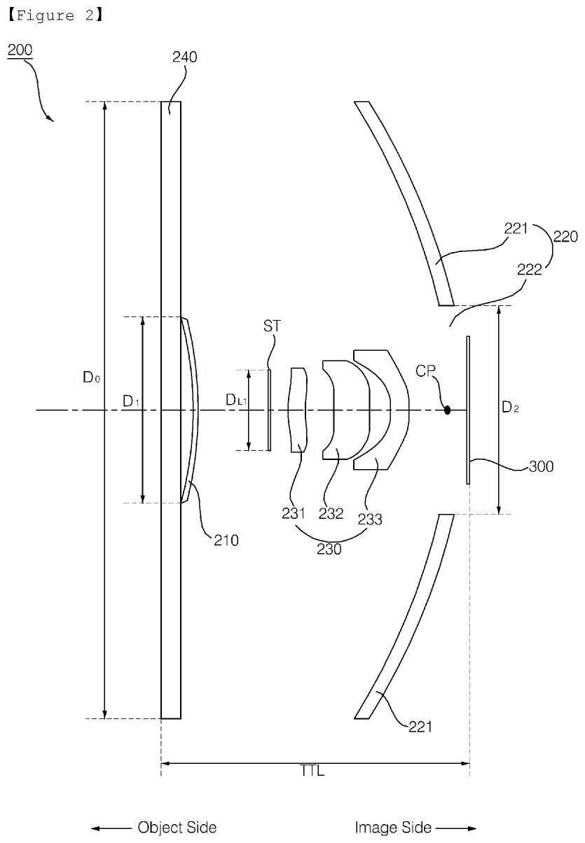

FIG. 2 is a diagram illustrating an imaging lens 200 according to an embodiment of the present disclosure. In FIG. 2, the spherical or aspherical shape of the mirror or lens is suggested just as an example but is not limited thereto.

In the present disclosure, the term ‘target surface’ refers to a surface of a lens facing the object side based on an optical axis, and the term ‘image-forming surface’ refers to a surface of a lens facing the image side based on the optical axis. The ‘target surface’ may be defined with the same meaning as the ‘object-side surface’, and the ‘image-forming surface’ may be defined with the same meaning as the ‘image-side surface’.

In addition, in the present disclosure, the term ‘image surface’ refers to a surface on which light passed through the lens is formed as an image. In the present disclosure, a light receiving surface of the image sensor may be located on the ‘image surface’. Therefore, in the description of a camera module of the present disclosure or an electronic device including the camera module, ‘image surface’ and ‘image sensor surface’ may be interpreted as the same meaning.

Further, in the present disclosure, “positive power” of a mirror or lens indicates a converging mirror or converging lens that converges parallel light, and “negative power” of a mirror or lens indicates a diverging mirror or diverging lens that diverges parallel light.

Referring to the drawing, the imaging lens 200 may include a front mirror 210, a rear mirror 220, and a lens group 230.

The rear mirror 220 may include a reflection area 221 and a transmission area 222.

The reflection area 221 is an area that converges a light while reflecting the incident light toward an object side. To this end, the reflection area 221 may be a mirror that has a positive power and has a concave object-side surface.

The transmission area 222 is an area in which light transmitted through the lens group 230 travels to an image sensor 300, and is formed in the center of the rear mirror 200. For example, the rear mirror 220 and the transmission area 222 may have a circular shape when viewed in a plane perpendicular to the optical axis, and the center of the transmission area 222 may coincide with the center of the rear mirror 220.

The front mirror 210 is a mirror that reflects the light reflected from the reflection area 221 of the rear mirror 220 upward. To this end, the front mirror 210 may be a mirror that has a negative power, and has a convex image-side surface.

The size (diameter) of the front mirror 210 may be changed by adjusting the refractive power of the rear mirror 220. For example, as the refractive power of the rear mirror 220 becomes higher (increased), the diameter of the front mirror 210 may be decreased.

A reflective layer may be formed on the mirror surfaces (reflecting surfaces) of the front mirror 210 and the rear mirror 220 so as to reflect light. The reflective layer may be formed of a material having excellent reflection characteristics, for example, a material composed of Ag, Ni, Al, Rh, Pd, Ir, Ru, Mg, Zn, Pt, Au, Hf, and a selective combination thereof.

The lens group 230 may include a plurality of lenses that transmit the light reflected from the front mirror 210 to the image surface, and all may be disposed between the rear mirror 220 and the front mirror 210 based on the optical axis. Although the drawing illustrates that three lenses are included in the lens group 230, the number of lenses included in the lens group 230 is not limited thereto.

The lens group 230 may focus the light reflected from the front mirror 210, and may suppress aberration and the like through a plurality of lenses included in the lens group. At least one of the plurality of lenses included in the lens group 230 may include an aspherical lens, and all of the plurality of lenses may have a rotation symmetric shape based on the optical axis.

Meanwhile, the lens group 230 and the front lens 240 may be made of a glass material or a plastic material. When the lens is made of a plastic material, the manufacturing cost can be greatly reduced.

In the imaging lens 200 having such a structure, the light incident to the imaging lens 200 is converged while being reflected by the rear mirror 220 toward the object side, the light reflected by the rear mirror 220 is reflected again by the front mirror 210 toward the image side, and the light reflected by the front mirror 210 may transmit the lens group 230 to proceed to the image sensor 300.

Accordingly, the path of the light incident to the imaging lens 200 is overlapped by the front mirror 210 and the rear mirror 220. Accordingly, the length of the imaging lens 200 may be reduced. In addition, all of the lens groups 230 are positioned between the front mirror 210 and the rear mirror 220, thereby suppressing an increase in the length of the imaging lens 200.

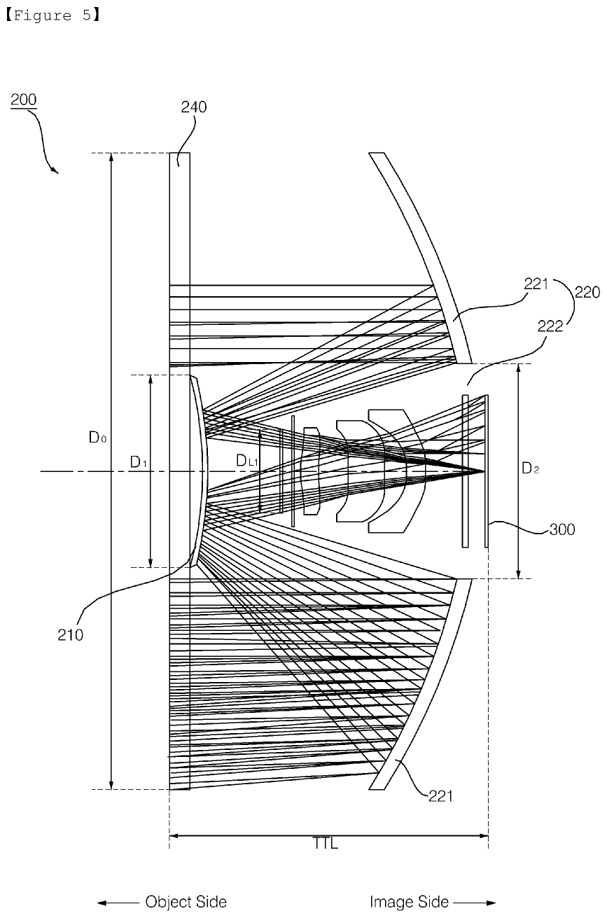

In addition, the brightness Fno of the lens may be increased, and resolution may be increased by increasing the entrance pupil diameter of the imaging lens 200. The detailed structure of the imaging lens 200 of the present disclosure will be described in detail with reference to FIGS. 5 to 11 below.

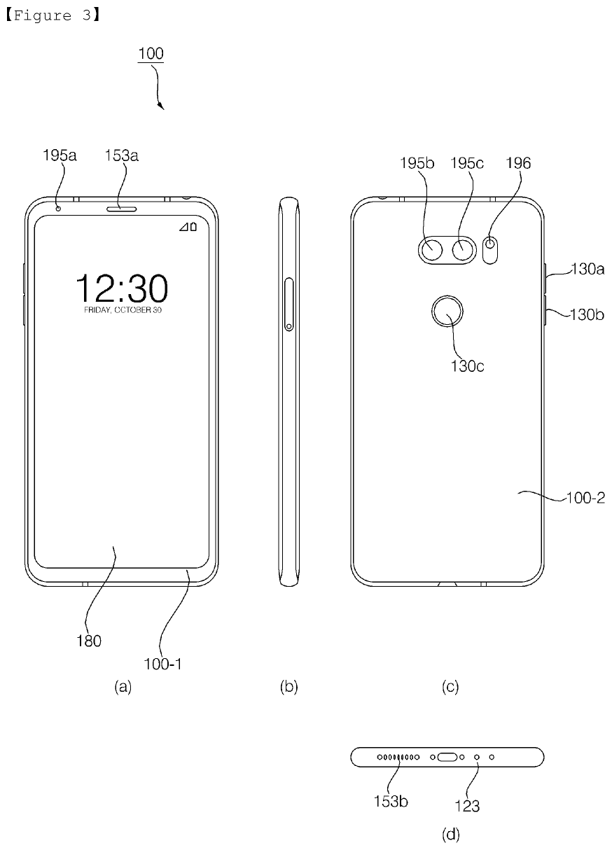

FIG. 3 is a view showing an outer shape of the mobile terminal 100 including the imaging lens 200 according to an embodiment of the present disclosure. FIG. 3A is a front view of the mobile terminal 100, FIG. 3B is a side view, FIG. 3C is a rear view, and FIG. 3D is a bottom view.

Referring to FIG. 3, the case constituting the outer shape of the mobile terminal 100 is formed by a front case 100-1 and a rear case 100-2. Various electronic components may be embedded in a space formed by the front case 100-1 and the rear case 100-2.

Specifically, a display 180, a first camera device 195a, a first sound output module 153a, and the like may be disposed in the front case 100-1. In addition, first to second user input units 130a and 130b may be disposed on a side surface of the rear case 100-2.

The display 180 may operate as a touch screen by overlapping a touch pad in a layered structure.

The first sound output module 153a may be implemented in the form of a receiver or a speaker. The first camera device 195a may be implemented in a form suitable for photographing an image or a moving picture of a user or the like. In addition, a microphone 123 may be implemented in a form suitable for receiving a user's voice, other sounds, and the like.

The first to second user input units 130a and 130b and a third user input unit 130c described later may be collectively referred to as a user input unit 130.

A first microphone (not shown) may be disposed in the image side of the rear case 100-2, i.e., in the image side of the mobile terminal 100, for collecting audio signals, and a second microphone 123 may be disposed in the lower side of the rear case 100-2, i.e., in the lower side of the mobile terminal 100, for collecting audio signals.

A second camera device 195b, a third camera device 195c, a flash 196, and a third user input unit 130c may be disposed on the rear surface of the rear case 100-2.

The second and third camera devices 195b and 195c may have a photographing direction substantially opposite to that of the first camera device 195a, and may have different pixels from the first camera device 195a. The second camera device 195b and the third camera device 195c may have different angles of view to expand a photographing range. A mirror (not shown) may be additionally disposed adjacent to the third camera device 195c. In addition, another camera device may be further installed adjacent to the third camera device 195c to be used for photographing a 3D stereoscopic image, or may be used for photographing an additional different angle of view.

The second camera device 195b or the third camera device 195c may include the imaging lens 200 according to an embodiment of the present disclosure. In this case, the camera device including the imaging lens 200 may work as a telephoto lens camera that has a narrow angle of view and photographs a distant subject.

A flash 196 may be disposed adjacent to the second camera device 195b or the third camera 195c. The flash 196 illuminates light toward the subject when the subject is photographed by the second camera device 195b or the third camera 195c.

A second sound output module 153b may be additionally disposed in the rear case 100-2. The second sound output module may implement a stereo function together with the first sound output module 153a, and may be used for a call in a speakerphone mode.

A power supply unit 190 for supplying power to the mobile terminal 100 may be mounted in the rear case 100-2 side. The power supply unit 190 is, for example, a rechargeable battery, and may be configured in the rear case 100-2 as one body or may be detachably coupled to the rear case 100-2 for charging or the like.

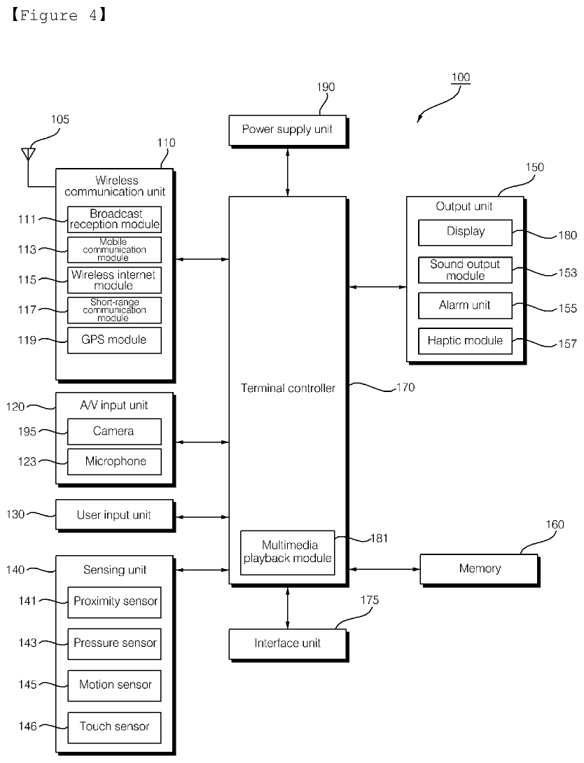

FIG. 4 is a block diagram of the mobile terminal 100 of FIG. 3.

Referring to FIG. 4, the mobile terminal 100 may include a wireless communication unit 110, an audio/video (A/V) input unit 120, a user input unit 130, a sensing unit 140, an output unit 150, a memory 160, an interface unit 175, a terminal controller 170, and a power supply unit 190. When these components are implemented in actual applications, two or more components may be combined into one component, or one component may be subdivided into two or more components as needed.

The wireless communication unit 110 may include a broadcast reception module 111, a mobile communication module 113, a wireless Internet module 115, a short-range communication module 117, and a GPS module 119.

The broadcast reception module 111 may receive at least one of a broadcast signal and broadcast-related information from an external broadcast management server through a broadcast channel. The broadcast signal and/or broadcast related information received through the broadcast reception module 111 may be stored in the memory 160.

The mobile communication module 113 may transmit/receive a wireless signal to/from at least one of a base station, an external terminal, and a server on a mobile communication network. Here, the wireless signal may include a voice call signal, a video call signal, or various types of data according to text/multimedia message transmission/reception.

The wireless Internet module 115 refers to a module for wireless Internet access, and the wireless Internet module 115 may be embedded in the mobile terminal 100 or externally provided.

The short-range communication module 117 refers to a module for short-range communication. Bluetooth, Radio Frequency Identification (RFID), infrared data association (IrDA), Ultra Wideband (UWB), ZigBee, Near Field Communication (NFC), etc. may be used as a short-range communication technology.

The Global Position System (GPS) module 119 receives location information from a plurality of GPS satellites.

The audio/video (A/V) input unit 120 is for inputting an audio signal or a video signal, and may include a camera device 195, a microphone 123, and the like.

The camera device 195 may process an image frame such as a still image or a moving image obtained by the image sensor in a video call mode or a photographing mode. Then, the processed image frame may be displayed on the display 180.

The camera device 195 may include the imaging lens 200 according to an embodiment of the present disclosure.

The image frame processed by the camera device 195 may be stored in the memory 160 or transmitted to the outside through the wireless communication unit 110. Two or more camera devices 195 may be provided according to the configuration of the electronic device.

The microphone 123 may receive an external audio signal by a microphone in a display off mode, e.g., a call mode, a recording mode, or a voice recognition mode, and process it as electrical voice data.

Meanwhile, a plurality of microphones 123 may be disposed at different positions. The audio signal received from each microphone may be processed by the terminal controller 170 or the like.

The user input unit 130 generates key input data input by a user to control the operation of the electronic device. The user input unit 130 may include a keypad, a dome switch, a touch pad (static/resistance), and the like, through which a command or information can be input by a user's pressing or touch operation. In particular, when the touch pad forms a mutual layer structure with the display 180 described later, this may be referred to as a touch screen.

The sensing unit 140 may generate a sensing signal for controlling the operation of the mobile terminal 100 by detecting the current state of the mobile terminal 100, such as the open/closed state of the mobile terminal 100, the position of the mobile terminal 100, and the contact of user.

The sensing unit 140 may include a proximity sensor 141, a pressure sensor 143, a motion sensor 145, a touch sensor 146, and the like.

The proximity sensor 141 may detect the presence or absence of an object approaching the mobile terminal 100 or an object existing in the vicinity of the mobile terminal 100 without mechanical contact. In particular, the proximity sensor 141 may detect a proximity object by using a change in an alternating current magnetic field or a change in a static magnetic field, or by using a rate of change in capacitance.

The pressure sensor 143 may detect whether pressure is applied to the mobile terminal 100, and the magnitude of the pressure.

The motion sensor 145 may detect a position or movement of the mobile terminal 100 by using an acceleration sensor, a gyro sensor, or the like.

The touch sensor 146 may detect a touch input by a user's finger or a touch input by a specific pen. For example, when a touch screen panel is disposed on the display 180, the touch screen panel may include a touch sensor 146 for detecting location information and intensity information of a touch input. The sensing signal detected by the touch sensor 146 may be transmitted to the terminal controller 170.

The output unit 150 is for outputting an audio signal, a video signal, or an alarm signal. The output unit 150 may include a display 180, a sound output module 153, an alarm unit 155, and a haptic module 157.

The display 180 displays and outputs information processed by the mobile terminal 100. For example, when the mobile terminal 100 is in a call mode, a user interface (UI) or graphic user interface (GUI) related to a call is displayed. In addition, when the mobile terminal 100 is in a video call mode or a photographing mode, the photographed or received image may be displayed individually or simultaneously, and a UI and a GUI may be displayed.

Meanwhile, as described above, when the display 180 and the touchpad form a mutual layer structure and are configured as a touch screen, the display 180 may be used as an input device capable of inputting information by a user's touch in addition to an output device.

The sound output module 153 may output audio data received from the wireless communication unit 110 or stored in the memory 160 in a call signal reception, a call mode or a recording mode, a voice recognition mode, a broadcast reception mode, and the like. In addition, the sound output module 153 outputs an audio signal related to a function performed in the mobile terminal 100, for example, a call signal reception sound, a message reception sound, and the like. The sound output module 153 may include a speaker, a buzzer, and the like.

The alarm unit 155 outputs a signal for notifying the occurrence of an event in the mobile terminal 100. The alarm unit 155 outputs a signal for notifying the occurrence of an event in a form excluding an audio signal or a video signal. For example, a signal may be output in the form of vibration.

The haptic module 157 generates various tactile effects that a user can feel. The representative example of the tactile effect generated by the haptic module 157 is a vibration effect. When the haptic module 157 generates vibration as a tactile effect, the intensity and pattern of the vibration generated by the haptic module 157 may be converted, and different vibrations may be synthesized and outputted or outputted sequentially.

The memory 160 may store a program for processing and controlling the terminal controller 170, and may also perform a function for temporary storage of input or output data (e.g., phone book, message, still image, moving image, etc.).

The interface unit 175 functions as an interface with all external devices connected to the mobile terminal 100. The interface unit 175 may receive data or receive power from an external device and transmit it to each component inside the mobile terminal 100, and may allow data inside the mobile terminal 100 to be transmitted to an external device.

The mobile terminal 100 may be provided with a fingerprint recognition sensor for recognizing a user's fingerprint, and the terminal controller 170 may use fingerprint information detected through the fingerprint recognition sensor as an authentication means. The fingerprint recognition sensor may be embedded in the display 180 or the user input unit 130.

The terminal controller 170 generally controls the overall operation of the mobile terminal 100 by controlling the operation of each unit. For example, it may perform pertinent control and processing for voice call, data communications, video call, and the like. In addition, the terminal controller 170 may include a multimedia playback module 181 for multimedia playback. The multimedia playback module 181 may be configured as hardware inside the terminal controller 170, or may be configured as software separately from the terminal controller 170.

Meanwhile, the terminal controller 170 may include an application processor (not shown) for driving an application. Alternatively, the application processor (not shown) may be provided separately from the terminal controller 170.

In addition, the power supply unit 190 may receive external power and internal power under the control of the terminal controller 170 to supply power necessary for the operation of each component.

The power supply unit 190 may include a connection port, and the connection port may be electrically connected to an external charger that supplies power for charging the battery. Meanwhile, the power supply unit 190 may be configured to charge the battery in a wireless manner without using the connection port.

FIG. 5 is a diagram illustrating a path through which light is incident in an imaging lens according to an embodiment of the present disclosure.

Referring to FIGS. 2 and 5 together, the lens group 230 may include a plurality of lenses disposed along the optical axis from the object-side surface to the image-side surface. It is assumed that the lenses included in the lens group 230 are referred to as a first lens to a N-th lens sequentially from the object-side surface to the image-side surface. In this example, it is assumed that the number of lenses is N (N is a natural number greater than or equal to 2).

All of the lens groups 230 may be positioned between the front mirror 210 and the rear mirror 220.

In the lens group 230, the object-side surface of the first lens 231 closest to the object side may be spaced apart from the image-side surface of the front mirror 210, and may be located in the image side than the image-side surface of the front mirror 210.

In addition, in the lens group 230, the N-th lens closest to the image side may be located farther from the image sensor 300 than the rear mirror 220. The transmission area 222 of the rear mirror 220 has a circular shape existing on a plane perpendicular to the optical axis. Accordingly, the center point (CP of FIG. 2) of the transmission area 220 may be located between the image surface and the image-side surface of the N-th lens, on the optical axis.

Meanwhile, the image sensor 300 may be located in the transmission area 222 of the rear mirror 220. In this case, the center point CP of the transmission area 220 may coincide with the image surface, on the optical axis, and the image-side surface of the N-th lens may be located in the object side than the image surface or the center point CP of the transmission area 220, on the optical axis.

Accordingly, since all of the lens groups 230 are positioned between the front mirror 210 and the rear mirror 220, an increase in the length of the imaging lens 200 may be suppressed.

The image sensor 300 is an element that forms an image of a subject that passed through the imaging lens 200. The image sensor 300 may include a plurality of pixels disposed in a matrix form. The image sensor 300 may include at least one photoelectric conversion element capable of converting an optical signal into an electrical signal. For example, the image sensor 300 may be a charge-coupled device (CCD) or a complementary metal-oxide semiconductor (CMOS).

Meanwhile, the image sensor 300 may be divided into a first area 310 at the center of the sensor and a second area 320 at the periphery of the sensor.

The first area 310 may include a plurality of pixels, and a corresponding pixel may have a first pixel density. The second area 320 may include a plurality of pixels, and a corresponding pixel may have a first pixel density. Here, the pixel density may be defined as the number of pixels per unit area.

The first pixel density may be greater than the second pixel density. In this case, since the resolution of the first area 310, which is the central area of the sensor, is increased, the image sensor 300 may increase the imaging resolution of the subject positioned at the center of the angle of view of the imaging lens 200.

Meanwhile, the second pixel density may be greater than the first pixel density. In this case, since the resolution of the second area 320, which is the sensor peripheral area, increases, the image sensor 300 may increase the imaging resolution of the subject located in the peripheral portion of the angle of view of the imaging lens 200. Accordingly, deterioration of image quality due to the peripheral portion of the imaging lens 200 may be suppressed through the image sensor 300.

Meanwhile, referring to FIG. 5, the diameter DL1 of the first lens of the lens group 230 may be the smallest among the diameters of the lenses included in the lens group 230. In addition, the diameter DL1 of the first lens may be smaller than the diameter D1 of the front mirror 210 and the diameter D2 of the transmission area 222 of the rear mirror 220.

The stop surface (ST in FIG. 2) of the imaging lens 200 of the present disclosure may be located between the image-side surface of the front mirror 210 and the object-side surface of the first lens, by making the diameter DL1 of the first lens to be smaller than the diameter of other lens, the diameter of the front mirror 210, and the diameter of the transmission area 222,

Here, the stop means an aperture stop, and means the physical aperture that determines the magnitude of the light incoming the lens. The stop surface may be the surface or iris of the optical lens, but always exists as a physical surface.

As described above, the stop surface of the imaging lens 200 is positioned between the image-side surface of the front mirror 210 and the object-side surface of the first lens, thereby reducing the size of a shielding area (an area in which some of the light incident to the imaging lens 200 is blocked and does not reach the image sensor) of the imaging lens 200. Accordingly, the amount of shielded light among the light incident to the imaging lens 200 can be minimized, and Fno (F-number) of the imaging lens 200 can be reduced.

Meanwhile, the stop surface of the imaging lens 200 may include an aperture device. The aperture device may adjust the amount of light incident to the lens of the lens group 230 among the light reflected from the rear mirror 220 and the front mirror 210.

The aperture may have a mechanical structure capable of gradually increasing or decreasing the size of the opening to adjust the amount of incident light. As the opening of the aperture device becomes larger, the amount of incident light increases, and as the opening becomes smaller, the amount of incident light decreases.

In this case, the processor (not shown) of the camera module may control a driving circuit (not shown) so that the opening of the aperture device is variable, thereby adjusting the amount of light incident to the image sensor 300.

Meanwhile, referring to FIGS. 2 and 5, in the plurality of lenses included in the lens group 230, the diameter of each lens may be the same or larger as it progresses from the first lens located in the object side to the Nth lens located in the image side.

Specifically, when the diameters of the first to Nth lenses are referred to as DL1 to DLN, respectively, a conditional expression of DL1≤DL2≤ . . . ≤DLN-1≤DLN may be satisfied.

When the diameter of the lens located in the image side is smaller than the diameter of the lens located in the object side (when the above conditional expression is not satisfied), some of the light incident to the lens group 230 may not be received by the image sensor 300.

Meanwhile, the imaging lens 200 may further include a front lens 240 through which light incident from the object side transmits first.

The front lens 240 is a lens through which light incident from the object side to the imaging lens 200 is transmitted, and may be positioned in the front mirror 210 to the object side. For example, the front lens 240 may be positioned so that the object-side surface of the front mirror 210 and the image-side surface of the front lens 240 contact each other.

The front mirror 210 may be attached to the front lens 240 such that the object-side surface of the front mirror 210 contacts the image-side surface of the front lens 240. For example, the front mirror 210 may be attached to the front lens 240 by applying an adhesive material between the image-side surface of the front mirror 210 and the lower surface of the front lens 240. For example, a groove having a diameter equal to or smaller than the diameter of the front mirror 210 may be formed on the image surface of the front lens 240 so that the front mirror 210 can be attached. In this case, the front mirror 210 may be fitted to and assembled with the front mirror 210 by a press fit method or the like.

Meanwhile, an absorption film or the like may be coated on an image-side surface of the front lens 240 to which the front mirror 210 is attached or an object-side surface of the front lens 240 corresponding to a relevant image-side surface. Due to the absorption film, unnecessary reflection of light incident to the shielding area of the front mirror 240 can be suppressed. Meanwhile, the absorption film may be coated on the object-side surface (rear surface) of the front mirror 210.

Meanwhile, both surfaces of the front lens 240 may be a plane, and may be formed of a glass material or a plastic material. The front lens 240 may serve to protect the lens group 230, the front mirror 210, and the rear mirror 220 inside the imaging lens 200 from external impact. However, the shape and material of the front lens 240 is not limited thereto.

In the present disclosure, the distance from the object-side surface of the front lens 240 to the image surface may be referred to as a thickness (Total Top Length, or Total Track Length: TTL) of the imaging lens 200.

The thickness of the imaging lens 200 may be relatively small compared to the diameter D0 of the front lens 240. Specifically, the thickness of the imaging lens 200 may be designed to be 0.7 times or less of the diameter D0 of the front lens 240.

That is, the thickness of the imaging lens 200 and the diameter D0 of the front lens 240 may satisfy the conditional expression of 0<TTL/D0≤0.7.

When the TTL/D0 value is greater than 0.7, if the diameter of the entrance pupil is increased so as to increase the lens brightness, the thickness of the imaging lens 200 is increased, so that it may be difficult to mount on a mobile terminal or the like.

Meanwhile, the imaging lens 200 according to an embodiment of the present disclosure may satisfy the following conditional expression.

0<Fno≤3.5

Here, Fno is a constant indicating the brightness of the imaging lens 200. As Fno increases, the brightness of the imaging lens 200 becomes darker, and the amount of light received by the imaging lens 200 decreases in the same environment.

When Fno is greater than 3.5, the image quality of the image acquired by the imaging lens 200 in a dark place is deteriorated. Accordingly, in the imaging lens 200 of the present disclosure, the diameter of the entrance pupil can be increased through the structure of two mirrors and a lens group positioned between the mirrors, and Fno can be less than or equal to 3.5.

In the conventional lens having a periscope structure, in order not to increase the thickness of the mobile terminal, the diameter of the entrance pupil cannot be increased by a certain size or more. Therefore, it is difficult for the Fno to be 3.5 or less in the conventional lens having a periscope structure.

Meanwhile, the imaging lens 200 according to an embodiment of the present disclosure may satisfy the following conditional expression.

ANG≤6°

Here, ANG is a numerical value representing a half-angle of view of the imaging lens 200. The half angle of view means ½ of the entire angle of view of the imaging lens 200.

The imaging lens 200 of the present disclosure may be designed to have an ANG of 6 degrees or less, and thus, as a telephoto lens, it is possible to capture an image including a distant subject.

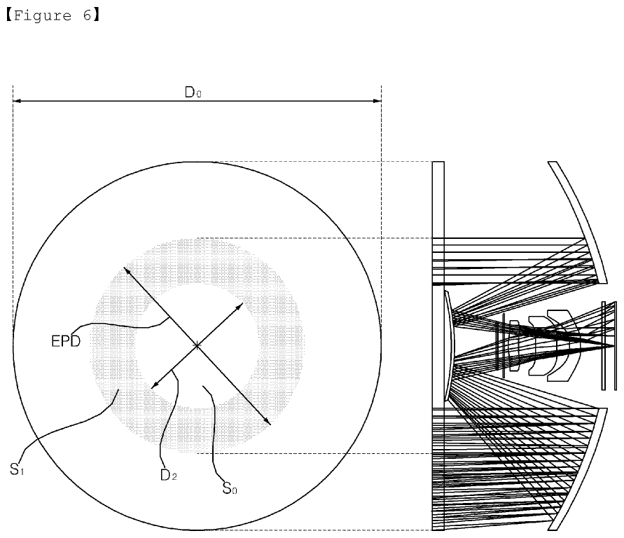

FIG. 6 illustrates an entrance pupil diameter (EPD) and a shielding area of the imaging lens 200 of FIG. 2.

The imaging lens 200 according to an embodiment of the present disclosure may satisfy the following conditional expression.

D2/EPD≤0.8

Here, EPD is the entrance pupil diameter of the imaging lens 200, and D2 is the diameter of the transmission area 222 of the rear mirror 220. The entrance pupil diameter of the imaging lens 200 may be defined as an area through which light that is vertically incident to the imaging lens 200 and then incident to the image sensor 300 passes through the imaging lens 200.

In the imaging lens 200 of the present disclosure, Fno may be determined by the entrance pupil diameter and the size of the shielding area. The size of the shielding area may be determined by the diameter of the transmission area 222 of the rear mirror 220. For example, the diameter of the shielding area may be proportional to the diameter of the transmission area 222 of the rear mirror 220. For example, the diameter of the shielding area may be the same as the diameter of the transmission area 222 of the rear mirror 220.

Referring to FIG. 6, an area in which light is vertically incident to the imaging lens 200 may have a circular shape having an entrance pupil diameter (EPD). The incident light may be shielded in proportion to the size of the transmission area 222 of the rear mirror 220, at a central portion of the area where the light is incident. In this case, the shielding area may be formed in a circular shape at a central portion where light is incident.

When the diameter D2 of the transmission area 222 is ½ times the entrance pupil diameter EPD, the area S0 of the shielding area is about 25% of the total area S1 of the area where light is incident. Accordingly, in this case, about 75% of the total light incident to the imaging lens 200 may be incident to the image sensor 300. Accordingly, the imaging lens 200 designed so that the entrance pupil diameter EPD satisfies Fno 2.0 may actually have a brightness performance of about Fno 2.4 level.

Meanwhile, when the diameter D2 of the transmission area 222 is 0.8 times the entrance pupil diameter EPD, the area S0 of the shielding area is about 64% of the total area S1 of the area where light is incident. Accordingly, in this case, about 36% of the total light incident to the imaging lens 200 may be incident to the image sensor 300. Accordingly, the imaging lens 200 designed so that the entrance pupil diameter (EPD) satisfies Fno 2.0 may actually have a brightness performance of about Fno 3.5 level.

When the D2/EPD value exceeds 0.8, the amount of light blocked by the shielding area increases. Therefore, even if the imaging lens 200 is designed so that the entrance pupil diameter satisfies Fno 2.0, it is difficult to actually implement the brightness performance of Fno 3.5 or less.

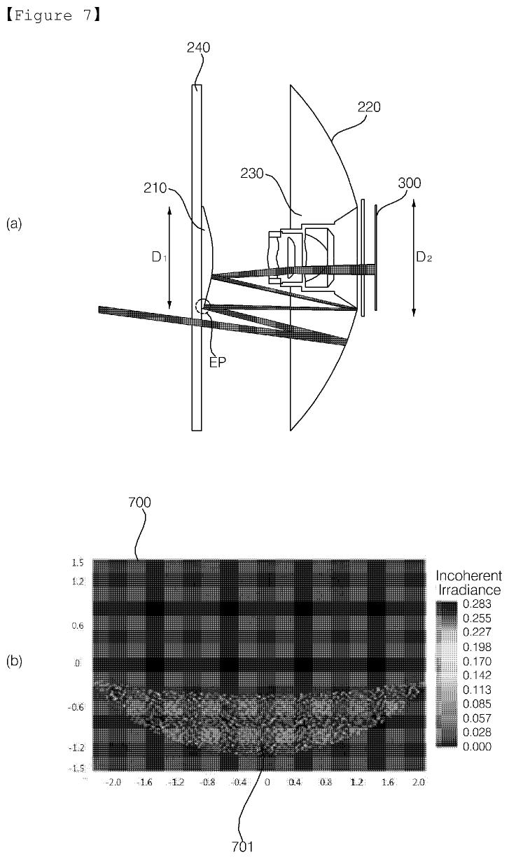

FIG. 7 illustrates a phenomenon in which stray light appears according to diameters of the front mirror 210 and the rear mirror 220 in the imaging lens 200 of FIG. 2. Specifically, FIG. 7A shows a part of an incident light path when the diameter of the front mirror 210 and the diameter of the rear mirror 220 are the same, and FIG. 7B shows the stray light that may appear in the photographed image in this case.

Stray light refers to light that causes an unnecessary noise shape in the image sensor 300 among light incident to the imaging lens 200. Accordingly, when the imaging lens 200 is not properly designed, a noise component due to stray light may occur in an image photographed by using the imaging lens 200.

In the imaging lens 200 according to an embodiment of the present disclosure, the diameter D1 of the front mirror 210 may be smaller than the diameter D2 of the transmission area 222 of the rear mirror 220.

Referring to FIG. 7A, when the diameter D1 of the front mirror 210 is equal to or larger than the diameter D2 of the transmission area 222 of the rear mirror 220, a portion of the light incident to the imaging lens 200 may be reflected by the rear mirror 220 and reflected by the front mirror 210, and then reflected by the rear mirror 220 and the front mirror 210 again, and may be incident to the lens group 230. In the imaging lens 200 of the present disclosure, such light may be referred to as a stray light.

In this case, the stray light may be incident to the sensor surface of the image sensor 300, in a half moon shape.

In FIG. 7B, x and y axes represent a horizontal axis and a vertical axis of the image sensor 300, respectively. Referring to FIG. 7B, when the diameter D1 of the front mirror 210 and the diameter D2 of the transmission area 222 of the rear mirror 220 are the same, it can be seen that the stray light 601 is incident to the lower end area of the image sensor 300, in the form of a half moon.

The half-moon-shaped stray light 601 may be formed larger on the image sensor 300 as the diameter D1 of the front mirror 210 becomes larger than the diameter D2 of the transmission area 222 of the rear mirror 220.

Therefore, in the imaging lens 200, the diameter D1 of the front mirror 210 is made to be smaller than the diameter D2 of the transmission area 222 of the rear mirror 220, thereby preventing the stray light from being formed in the photographed image. Accordingly, it is possible to prevent deterioration of the image quality of the captured image.

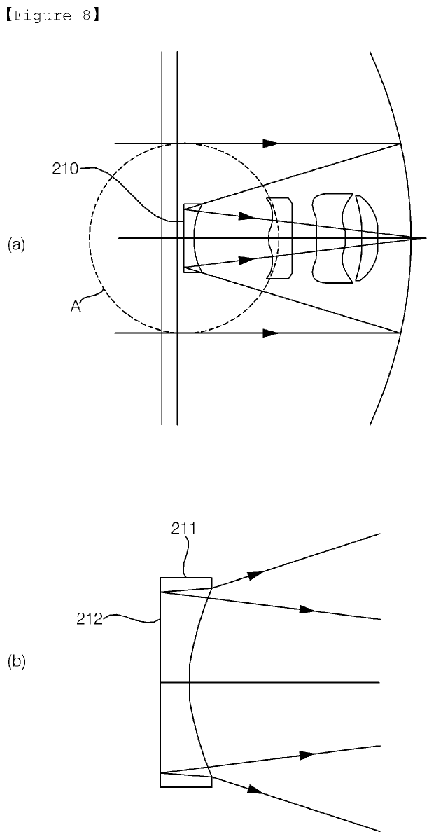

FIG. 8 shows another example of the front mirror 210 in the imaging lens 200 of FIG. 2.

Referring to FIG. 2, the front mirror 210 may be a mirror that has a negative power and has a convex image surface. The front mirror 210 may be a spherical mirror or an aspherical mirror. Since the convex-shaped aspherical mirror is a structure widely known in the related art, a detailed description thereof will be omitted.

Meanwhile, referring to FIG. 8, the front mirror 210 may be a plano-concave shape lens 211 in which an object-side surface is a plane and an image-side surface is concave. In this case, a reflective coating layer 212 capable of reflecting light may be formed on the object-side surface of the front mirror 210.

The reflective coating layer 212 is formed from a material having excellent reflection properties, e.g., Ag, Ni, Al, Rh, Pd, Ir, Ru, Mg, Zn, Pt, Au, Hf, and a material composed of a selective combination thereof.

When assembling the lens, the assembly tolerance may become smaller in the case of using the mirror including the reflective surface in a planar shape than in the case of using the mirror including the reflective surface having a curvature.

Accordingly, when the front mirror 210 is a plano-concave shaped lens 211 having a reflective coating layer 212 formed on one surface, assembly tolerance may be reduced. Accordingly, it is possible to suppress deterioration of the optical performance of the imaging lens 200 due to the assembly tolerance.

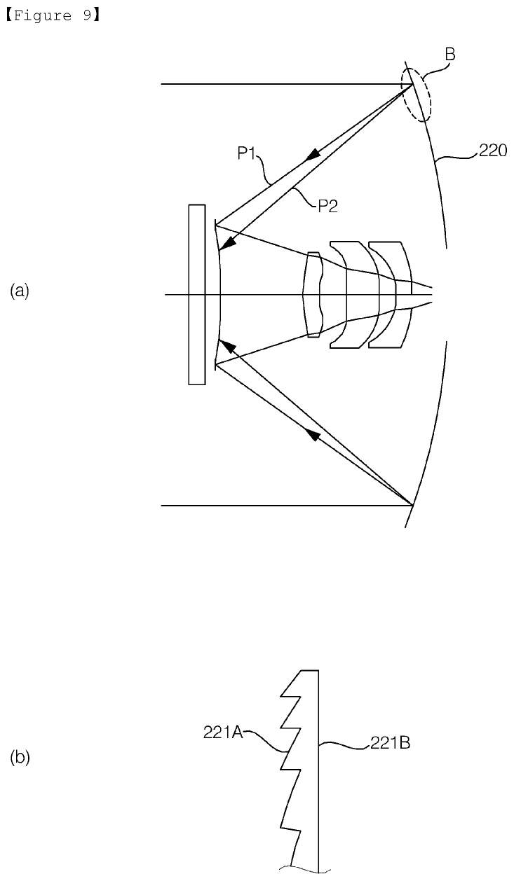

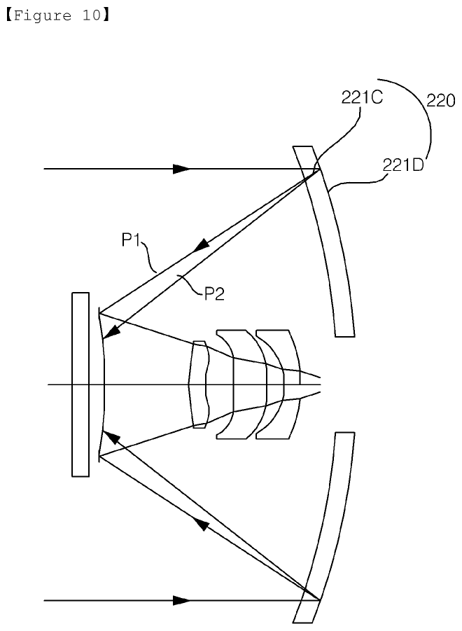

FIGS. 9 to 10 show various examples of the rear mirror 220 in the imaging lens 200 of FIG. 2.

Referring to FIG. 2, the rear mirror 220 may be a mirror that has positive power and has a concave object-side surface. The rear mirror 220 may be a spherical mirror or an aspherical mirror. Since the concave-shaped aspherical mirror is a structure widely known in the related art, a detailed description thereof will be omitted.

Meanwhile, referring to FIGS. 9 to 10, the rear mirror 220 may include a diffractive element or a refractive element. In this case, a reflective coating layer capable of reflecting light may be formed on the image-side surface of the diffractive element or the refractive element. Meanwhile, the object-side surface of the rear mirror 220 may be formed in the same shape as the surface of the diffractive element.

Referring to FIG. 9B, the rear mirror 220 includes a diffractive element, and the diffractive element may be a flannel lens 221A having a concave object-side surface. The image-side surface of the rear mirror 220 may have a curved surface in an upwardly convex shape, and a reflective coating layer 221B capable of reflecting light may be formed on the image-side surface.

Meanwhile, the rear mirror 220 may have an object-side surface having the same shape as the surface of a diffractive element such as a flannel lens. The object-side surface of the rear mirror 220 may be concave, and the surface may be formed in the form of a flannel lens 221A. A reflective coating layer 221B capable of reflecting light may be formed on the image-side surface of the rear mirror 220.

Meanwhile, although not shown in the drawing, the rear mirror 220 may have an object-side surface having the same shape as the surface of a diffractive optical element (DOE). The object-side surface of the rear mirror 220 may be concave, and the surface may be formed in the form of a diffractive optical element. A reflective coating layer capable of reflecting light may be formed on the image-side surface of the rear mirror 220.

Meanwhile, although not shown in the drawing, the rear mirror 220 may include a diffractive element, and the diffractive element may be a diffractive optical element having a concave object-side surface.

When the rear mirror 220 is in the form of a flannel lens 221A or a diffractive optical element, or includes the flannel lens 221A or a diffractive optical element, the angle at which light is reflected by the rear mirror 220 may increase.

FIG. 9A shows an optical path P1 in a case where the object-side surface of the rear mirror 220 has a general spherical or aspherical shape, and an optical path P2 in a case where the object-side surface of the rear mirror 220 is formed in the form of a flannel lens 221A or a diffractive optical element.

Referring to the drawing, when the object-side surface of the rear mirror 220 is formed in a flannel lens shape 221A or a diffractive optical element shape, the light reflected from the rear mirror 220 may be further refracted in the optical axis direction. Accordingly, the diameter of the front mirror 210 may be reduced, and the diameter or area of the shielding area of the imaging lens 200 may be reduced.

Meanwhile, referring to FIG. 10, the rear mirror 220 may include a refractive element, and the refractive element may be a lens 221C having a meniscus shape with a concave object-side surface. A reflective coating layer 221D capable of reflecting light may be formed on the image-side surface of the meniscus lens 221C. Accordingly, the angle at which the light is reflected by the rear mirror 220 may increase, and the light may be more effectively converged to the front mirror 210. Accordingly, the diameter of the front mirror 210 may be reduced, and the diameter or area of the shielding area of the imaging lens 200 may be reduced.

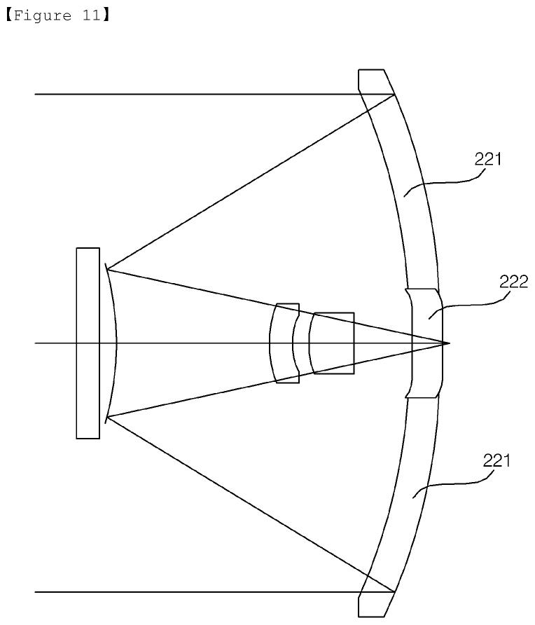

FIG. 11 shows various examples of the transmission area 222 of the rear mirror 220 in the imaging lens 200 of FIG. 2.

Referring to FIG. 2, the rear mirror 220 includes a transmission area 222. The transmission area 222 is an area in which the light transmitted through the lens group 230 travels to the image sensor 300, and is formed in the central portion of the rear mirror 200. The transmission area 222 may be an empty space.

Meanwhile, referring to FIG. 11, an optical element may be included in the transmission area 222. For example, at least one of a cover glass, a lens, a blue filter, an infrared filter, or a polarization filter may be positioned in the transmission area 222.

At least one lens may be included in the transmission area 222. The lens may refract incident light due to a shape of the lens and a difference in refractive index with respect to an external material. The lens may include a spherical lens or an aspherical lens. Preferably, the lens may be implemented as an aspherical lens. At least one of the target surface and the image-forming surface of the lens may have a convex shape, but the shape of the lens is not limited thereto. The material of the lens may be the same as that of the first lens 231 to the third lens 233 included in the lens group 230.

Accordingly, aberration of the image may be corrected or distortion may be corrected by the lens included in the transmission area 222.

Meanwhile, a blue filter, an infrared filter, or a polarization filter may be included in the transmission area 222. In this case, the amount of blue light incident to the image sensor 300 may be reduced by the blue filter, and the light incident to the image sensor 300 may be polarized by the polarization filter. However, in addition to the blue filter, the infrared filter, and the polarization filter, various types of filters may be included in the transmission area 222 depending on the purpose of use of the imaging lens 200.

Meanwhile, the transmission area 222 may include a cover glass. The cover glass may protect the imaging surface of the image sensor 300.

Hereinafter, an embodiment of the imaging lens 200 of the present disclosure will be described.

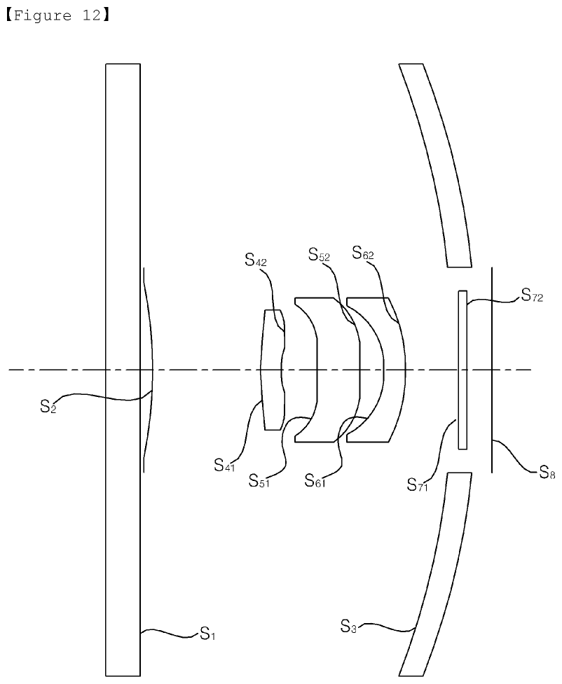

Design data of the imaging lens 200 of FIG. 12 is shown in Table 1 below. Table 1 shows the radius of curvature, thickness, or distance of each lens included in the imaging lens 200 according to an embodiment of the present disclosure. Here, the unit of the radius of curvature, the thickness or distance is millimeter (mm).

TABLE 1

| | Radius of | Thickness or | | |
|---|---|---|---|---|
| Surface | curvature (R) | distance (d) | | Element |
| S1 | Infinity | 5.300 | (S1-S3) | — |
| S2 | −15.0 | 1.900 | (S2-S41) | Front Mirror |

| | | | |
|---|---|---|---|
| S3 | −7.5 | — | Rear mirror |
| S8 | Infinity | — | Image surface |
| S41 | 3.800 | 0.400 | First lens |
| S42 | 4.900 | 0.600 | |
| S51 | −8.400 | 0.700 | Second lens |
| S52 | −4.900 | 0.400 | |
| S61 | −1.300 | 0.400 | Third lens |
| S62 | −2.600 | 0.500 | |
| S71 | Infinity | 0.110 | Filter |
| S72 | Infinity | 0.594 | |

In Table 1, the curvatures (S1, S2, S3, S8) and distances (S1-S3, S2-S41) of the image side surface of the front lens 240, the front mirror 210, the rear mirror 220, and the image sensor 300 are described, and curvatures (S41 to S72) and thicknesses or distances of the target surface and image-forming surface of the first to third lenses of the lens group 230 and the filter are described.

In the table, when the curvature is positive (+), it means a case of being curved convexly toward the object side, and when the curvature is negative (−), it means a case of being curved concavely toward the object side. When the curvature is infinity, the surface is flat.

Referring to Table 1 and FIG. 12 together, on the optical axis, the curvature of the image-forming surface S1 of the front lens 240 is infinite, the curvature of the front mirror 210 is −15, and the curvature of the rear mirror 220 is −7.5. The image-forming surface S1 of the front lens 240 is spaced 5.300 mm apart to a mirror surface S3 of the rear mirror 220 and disposed on the optical axis, and the image-forming surface S2 of the front mirror 210 is spaced 1.900 mm apart to the target surface S41 of the first lens and disposed on the optical axis.

On the optical axis, the distance (thickness) from the target surface S41 of the first lens to the image-forming surface S42 is 0.400 mm, the distance (thickness) from the target surface S51 of the second lens to the image-forming surface S52 is 0.700 mm, the distance (thickness) from the target surface S61 of the third lens to the image-forming surface S62 is 0.400 mm, and the distance (thickness) from the target surface S71 of the filter to the image-forming surface S72 is 0.110 mm.

Meanwhile, the image-forming surface S42 of the first lens is spaced 0.600 mm apart to the target surface S51 of the second lens and disposed on the optical axis, the image-forming surface S52 of the second lens is spaced 0.400 mm apart to the target surface S61 of the third lens and disposed on the optical axis, the image-forming surface S62 of the third lens is spaced 0.500 mm apart to the target surface S71 of the filter and disposed on the optical axis, and the image-forming surface S72 of the filter is spaced 0.594 mm apart to the image surface S8 of the image sensor and disposed on the optical axis.

In the first lens 231, the target surface S41 may be convex toward the object side and the image-forming surface S42 may be concave toward the image side.

Table 2 shows the conic constant k and the aspheric coefficient of the lens surface of each lens included in the imaging lens 200 according to an embodiment of the present disclosure.

TABLE 2

| Surface | k | r⁴ | r⁶ |
|---|---|---|---|
| S2 | −1.5 | 0 | 0 |
| S3 | −17.0 | 0 | 0 |
| S41 | −5.6 | −0.007 | −0.042 |
| S42 | −70.0 | −0.057 | −0.042 |
| S51 | 0.0 | −0.120 | −0.024 |
| S52 | 1.0 | −0.103 | −0.027 |
| S61 | −0.5 | −0.069 | −0.011 |
| S62 | 0.1 | −0.022 | 0.021 |

Referring to Table 2, the mirror surfaces (reflecting surfaces) of the front mirror 210 and the rear mirror 220 are aspherical, and the first lens 231 to the third lens 233 are aspherical lenses. However, at least one of the mirror surfaces (reflecting surfaces) of the front mirror 210 and the rear mirror 220 may be a spherical surface, and at least one of the first to third lenses may be a spherical lens, and is not limited to the example shown in Table 2.

Meanwhile, referring to Table 3, it can be seen that the imaging lens 200 according to an embodiment of the present disclosure satisfies the above-described characteristics and conditional expressions.

It can be seen that the imaging lens 200 is designed so that the entrance pupil diameter (EPD) satisfies Fno 2.0, and actually has a brightness performance of about Fno 2.4 level (effective Fno 2.4).

Accordingly, the imaging lens 200 has improved optical performance, can be applied to electronic devices such as the mobile terminal 100 with a compact size, and can photograph high-quality images in a dark environment.

TABLE 3

| | | |
|---|---|---|
| EFL | 20.5 | mm |
| Fno | 2.0 | (effective 2.4 @25% blocking) |
| EPD | 9.4 | mm |
| TTL | 6.3 | mm (without cover glass) |
| ICD | 4.0 | mm |
| (image circle diameter) | | |

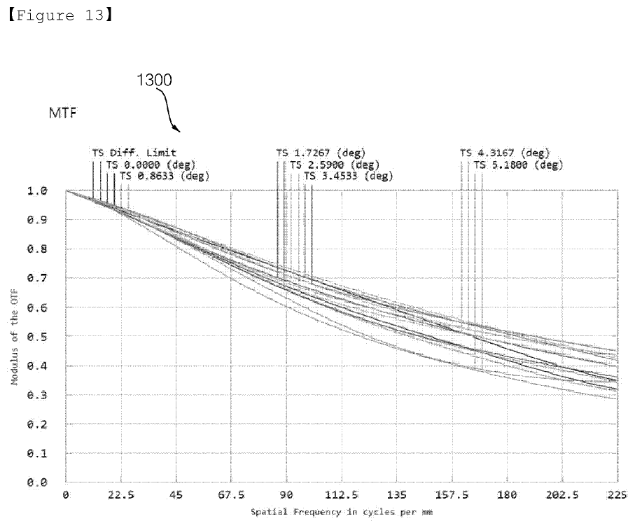

FIG. 13 illustrates a modulation transfer function (MTF) chart 1300 of the imaging lens 200 of FIG. 2.

In the drawing, each curve represents a MTF curve (TS Diff. Limit in FIG. 13) of the diffraction limit and a MTF curve (TS_0.0000(deg) to TS_5.1000(deg) in FIG. 13) according to the incident angle of light incident to the imaging lens 200. In the curve, the X-axis is spatial frequency, the spatial frequency means the number of lines existing within 1 mm, and the unit is line pair per millimeter (lp/mm). The Y-axis represents contrast.

Here, the diffraction limit represents the absolute limit of lens performance. In general lens, the MTF curve cannot go above the diffraction limit, and as the MTF curve approaches the diffraction limit curve, it means that the optical performance is excellent.

In the case of the imaging lens 200 according to an embodiment of the present disclosure, since the effect of shielding incident light by the transmission area 222 of the rear mirror 220 varies as the angle of view increases, the phenomenon of having an MTF value that exceeds the diffraction limit occurs. In addition, due to the effect of shielding incident light by the transmission area 222 of the rear mirror 220, the diffraction limit is lower than that of a general optical system having no shielding.

As shown in the MTF chart 1300, in the imaging lens 200 of the present disclosure, the MTF curves according to the angle of incidence are all located near the MTF curve of the diffraction limit. That is, it can be seen that the optical performance of the imaging lens 200 according to an embodiment of the present disclosure is excellent.

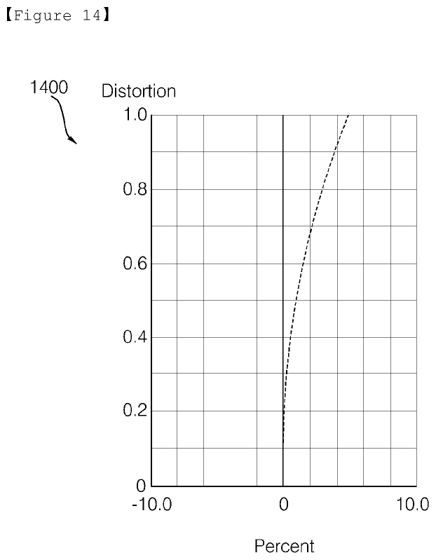

FIG. 14 is a graph 1300 illustrating distortion of the imaging lens 200 of FIG. 2.

In FIG. 14, the Y-axis means the size of an image, and the X-axis means a focal length (mm unit) and degree of distortion (% unit). As each of curves approaches the Y-axis, the aberration correction function of the imaging lens 200 may be improved. Referring to the graph 1400 of FIG. 14, the imaging lens 200 according to an embodiment of the present disclosure has a maximum distortion level of 5% or less, which shows an excellent level of distortion. The lens group 230 is all located between the front mirror 210 and the rear mirror 220 to suppress an increase in the thickness of the imaging lens 200 and, at the same time, to minimize aberration occurring in the imaging lens 200.

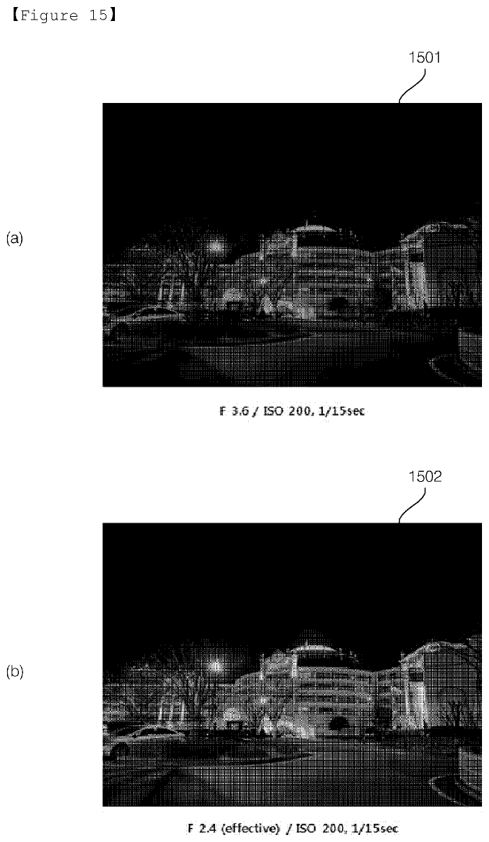

FIG. 15 shows a result of comparing an image photographed using the imaging lens 200 of FIG. 2 with an image photographed using a conventional lens.

FIG. 15A shows an image 1501 photographed using a conventional imaging lens, and FIG. 15B shows an image 1502 photographed using an imaging lens 200 according to an embodiment of the present disclosure.

Referring to FIG. 15A, an image 1501 photographed using a conventional general imaging lens was photographed under conditions of Fno 3.6, ISO 200, and a shutter speed of 1/15 sec. As can be seen from the image 1501, it can be seen that a building, a road, a car, and a flower bed are darkly photographed because the amount of light required for photographing the image is insufficient.

Referring to FIG. 15B, an image 1502 photographed by the imaging lens 200 according to an embodiment of the present disclosure has the same ISO value and shutter speed conditions compared with the photographing condition of FIG. 15A. As can be seen from the image 1502, it can be seen that buildings, roads, flower beds, and the like are photographed brighter than the image 1501 photographed with a conventional imaging lens.

The imaging lens 200 of the present disclosure has an Fno of 2.4, and in this case, the amount of light received by the lens is about twice (one step) greater than that of the conventional lens of Fno 3.6. This is because, in the imaging lens 200 of the present disclosure, the brightness performance of the lens can be improved by disposing all the lenses between the two reflective mirrors and increasing the incident pupil diameter compared to the lens thickness.

Accordingly, under the same light conditions and the same photographing conditions, the imaging lens 200 of the present disclosure can receive a larger amount of light and obtain a brighter and clearer image.

Although the present disclosure has been described with reference to specific embodiments shown in the drawings, it is apparent to those skilled in the art that the present description is not limited to those exemplary embodiments and is embodied in many forms without departing from the scope of the present disclosure, which is described in the following claims. These modifications should not be individually understood from the technical spirit or scope of the present disclosure.

1. An imaging lens comprising:
a rear mirror comprising a transmission area and a reflection area for reflecting light incident from an object side to the object side;
a front mirror for reflecting the light reflected from the reflection area of the rear mirror to an image side; and
a lens group comprising a plurality of lenses for transmitting the light reflected from the front mirror to an image surface,
wherein the lens group is all disposed between the rear mirror and the front mirror based on an optical axis.

2. The imaging lens of claim 1, wherein a center point of the transmission area, on the optical axis, is located between an image-side surface of a lens located closest to an image side among the plurality of lenses and the image surface.

3. The imaging lens of claim 1, wherein a diameter D1 of the front mirror is smaller than a diameter D2 of the transmission area of the rear mirror.

4. The imaging lens of claim 1, wherein the lens group comprises a first lens located closest to the object side,
wherein a diameter D_{L1} of the first lens is the smallest among diameters of lenses included in the lens group.

5. The imaging lens of claim 4, wherein the diameter D_{L1} of the first lens is smaller than the diameter D1 of the front mirror.

6. The imaging lens of claim 4, wherein the lens group comprises the first lens to an N-th lens (N is a natural number equal to or greater than 2) positioned in order from the object side to the image side, and
when diameters of the first lens to the N-th lens are D_{L1} to D_{LN}, respectively,
a conditional expression D_{L1}≤D_{L2}≤ . . . ≤D_{LN-1}≤DLN is satisfied.

7. The imaging lens of claim 4, wherein a stop surface is positioned between the front mirror and an object-side surface of the first lens.

8. The imaging lens of claim 4, further comprising a front lens which transmits the light incident from the object side, has both surfaces that are flat, and positioned in the front mirror to the object side, and
when a diameter of the front lens is D0 and a distance from the object-side surface of the front lens to an image surface is TTL,
a conditional expression 0<TTL/D0≤0.7 is satisfied.

9. The imaging lens of claim 1, wherein when a constant representing a brightness of the imaging lens is Fno,
a conditional expression 0<Fno≤3.5 is satisfied.

10. The imaging lens of claim 1, wherein when a half angle of view of the imaging lens is ANG,
a conditional expression ANG≤6° is satisfied.

11. The imaging lens of claim 1, wherein when an entrance pupil diameter of the imaging lens is EPD, and a diameter of the transmission area of the rear mirror is D2,
a conditional expression D2/EPD≤0.8 is satisfied.

12. The imaging lens of claim 1, wherein the front mirror is an aspherical mirror that has a negative power and has a convex image side surface.

13. The imaging lens of claim 1, wherein the front mirror is a plano-concave type lens which has an object-side surface that is flat, and has an image-side surface that is concave,
wherein a reflective coating layer capable of reflecting light is formed on the object-side surface of the front mirror.

14. The imaging lens of claim 1, wherein the rear mirror is an aspherical mirror that has a positive power, and has a concave object-side surface.

15. The imaging lens of claim 1, wherein the rear mirror comprises a diffractive element or a refractive element,
wherein a reflective coating layer capable of reflecting light is formed on an image side surface of the diffractive element or the refractive element.

16. The imaging lens of claim 15, wherein the refractive element is a meniscus shaped lens having a concave object-side surface.

17. The imaging lens of claim 15, wherein the diffractive element is a flannel lens or a diffractive optical element (DOE).

18. The imaging lens of claim 1, wherein a lens, a blue filter, or a polarizing filter is located in the transmission area of the rear mirror.

19-20. (canceled)

21. A camera module comprising:
an imaging lens comprising:
a rear mirror comprising a transmission area and a reflection area for reflecting light incident from an object side to the object side;
a front mirror for reflecting the light reflected from the reflection area of the rear mirror to an image side; and
a lens group comprising a plurality of lenses for transmitting the light reflected from the front mirror to an image surface,
wherein the lens group is all disposed between the rear mirror and the front mirror based on an optical axis;
a filter which selectively transmits light that passed through the imaging lens depending on a wavelength; and
an image sensor for receiving the light that passed through the filter.

22. An electronic device comprising:
a camera module comprising:
an imaging lens comprising:
a rear minor comprising a transmission area and a reflection area for reflecting light incident from an object side to the object side;
a front minor for reflecting the light reflected from the reflection area of the rear mirror to an image side; and
a lens group comprising a plurality of lenses for transmitting the light reflected from the front minor to an image surface,
wherein the lens group is all disposed between the rear mirror and the front minor based on an optical axis;
a filter which selectively transmits light that passed through the imaging lens depending on a wavelength; and
an image sensor for receiving the light that passed through the filter.
